(19) United States
(12) Patent Application Publication
(10) Pub. No.: US 2025/0238957 A1
(43) Pub. Date: Jul. 24, 2025

(54) DYNAMIC COMPRESSION IN USER INTERFACES

(71) Applicant: Comcast Cable Communications, LLC, Philadelphia, PA (US)

(72) Inventors: Wouter VAN BOESSCHOTEN, Ulvenhout (NL); Berend Hendrik HAANDRIKMAN, Spijkenisse (NL); Michiel VAN DER GEEST, Rotterdam (NL)

(21) Appl. No.: 18/417,957

(22) Filed: Jan. 19, 2024

(51) Int. Cl. G06T 9/00; H04N 21/231; H04N 21/431; H04N 21/858

(52) U.S. Cl. CPC G06T 9/00; H04N 21/23106; H04N 21/431; H04N 21/8586

(57) ABSTRACT

Methods are disclosed for leveraging dynamic texture compression mechanisms for user interfaces. By leveraging dynamic texture compression of an image compression service associated with a content service provider that caches each image to be displayed, a user device will severely downsize the memory consumption of the GPU of the user device.

### BACKGROUND

Resources, such as Graphics Processing Unit (GPU) memory are constantly constrained to create user interface experiences, especially when those user interfaces contain images or video content. This is due to the number of resources it takes to compress images to textures and upload them to the GPU. More often than not, the device is already resource constrained before this process begins. Most previous compression techniques, such as those used by video game engines, are entirely static. The images are pre-generated, packaged into an installer, and uploaded to the GPU for rendering. However, some user interfaces may need the capability to render dynamic images, such as those provided through content service providers. The more textures that can be stored directly on the GPU, the smoother the experience of the user interface will be. Therefore, new ways to leverage dynamic texture compression mechanisms for user interfaces are needed.

### SUMMARY

Methods are disclosed for leveraging dynamic texture compression mechanisms for user interfaces. When a user browses through a user interface of available content, a user device associated with the user interface may request an image, video, or the like to be compressed and downloaded dynamically on demand. An image compression service located on a cloud associated with a content service provider may receive the request. The image compression service may send a previously compressed version of the image stored in a cache directly to the user device to display on the user interface. Alternatively, if the image has not been previously compressed and stored in the cache, the image compression service may compress the requested image, store the newly compressed image in a cache, and send the newly compressed image to the user device for display on the user interface. As a result, the user device uses less resources to render the user interface, as each image or video to be displayed on the user interface may be dynamically compressed and cached on the cloud.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system.

FIG. 2 shows an example flow diagram of an example method.

FIG. 3 shows an example method.

FIG. 4 shows an example method.

FIG. 5 shows an example method.

FIG. 6 shows an example architecture.

### DETAILED DESCRIPTION OF ILLUSTRATIVE EMBODIMENTS

Methods are disclosed for leveraging dynamic texture compression mechanisms for user interfaces. The techniques for dynamic texture compression herein are applicable for any delivery method including but not limited to Dynamic Adaptive Streaming over Hypertext Transfer Protocol (HTTP) (DASH), HTTP Live Streaming (HLS), the QAM digital television standard, and adaptive bitrate (ABR) streaming.

For example, applications, such as Netflix, Amazon Prime, YouTube, and/or the like, running on user devices (e.g. set-top-boxes, mobile devices, Smart Televisions, etc.) may display a user interface, consisting of images and/or videos, such as poster art, thumbnails, and/or banners related to movies or television shows that are dynamically provided to a user by a content service provider (e.g. Netflix, Amazon Prime, Youtube, etc.) as the user navigates the application or website (e.g., one at a time as a user scrolls through a menu). The user interface may be displayed on a display element, such as a television, laptop screen, phone screen, and/or like, which may be separate from the user device or part of the user device.

In order to dynamically compress the textures of these interface elements, one at a time, when an image, or other interface element, needs to be displayed on the user interface (e.g., when a user navigates to a new page) an application framework engine associated with the user device located at a premises may receive location information, such as a Uniform Resource Locator (URL) and/or the like, of the next image intended to be displayed. The application framework engine of the user device may send a request to compress the image along with the location information of the image to an image compression service on the network associated with the content service provider. The image compression service may determine or fetch the original image from the associated content service provider based on the received location information.

Once the original image is determined, the image compression service may determine if the original image has previously been compressed by checking a cache of the content delivery network (CDN) associated with the content service provider. Determining if the original image has previously been compressed may also or alternatively comprise fetching the requested image based on the URL and receiving a compressed image from the cache. Images that have previously been compressed and cached may have a cache expiry (e.g. 24 hours, 12 hours, 1 hour, etc.). The cache may be periodically cleared. The clearing of the cache may be based on a pre-determined time. If the original image previously been compressed and cached, the image compression service may upload or send the compressed version of the image directly to the GPU of the user device.

If the original image has not been compressed, the image compression service may fetch the original image, compress it, and store it in the cache of the CDN. Storing the newly compressed image in the cloud may comprise changing the URL of the original image to a new URL associated with the newly compressed image stored in the cache. By changing the URL, subsequent requests for the image may retrieve the new URL associated with the newly compressed image stored in the cache instead of the old URL associated with the original uncompressed image stored by the content service provider. The image compression technique may be based on a lossy algorithm. For example, transform coding, such as Discrete Cosine Transform (DCT), color quantization, chroma subsampling, fractal compression, Ericsson Texture Compression 1 (ETC1), Ericsson Texture Compression 2 (ETC2), S3 Texture Compression (S3TC), and/or any other lossy texture compression algorithm or technique may suitable. The image compression technique may be based on a lossless algorithm. For example, run-length encoding, area image compression, predictive compression, such as Differential pulse-code modulation (DPCM), entropy encoding such as Huffman coding, chain codes, Lempel-Ziv-Welch (LZW) encoding, DEFLATE encoding, and or any other lossless texture compression algorithm or technique may suitable. Additionally, the cached image may have a cache expiry (e.g. 24 hours, 12 hours, 1 hour, etc.). The cache may be periodically cleared. The clearing of the cache may be based on a pre-determined time.

The compression process conducted by the image compression service may be unknown to the content service provider. The content service provide may provide information associated with the requested image(s) such as whether certain images or textures associated with the image should not be compressed. The image compression service may use that information to determine if parts or all of the requested image(s) should not be compressed.

The image compression service may send the compressed image to the user device. Once the user device receives the compressed image, the application framework engine of the user device may upload or send the compressed image to the GPU of the user device for rendering on the user interface. Once received, the user device may display, render, or otherwise make available the image on the user interface. This process may repeat, one at a time, for each of the subsequent images or interface elements that are to be displayed on the user interface as the user navigates the application or website.

As described above, a possible interface element to be displayed on the user interface may be a video. Video data described herein may comprise video frames or other images. Video frames may comprise pixels. A pixel may comprise a smallest controllable element of a video frame or image. A video frame or image may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel. The video may be processed by a video codec comprising an encoder and decoder. The video codec, including the encoder and decoder, may be a part of the image compression service located on the cloud associated with the content service provider. When video data is transmitted from one location to another, the encoder may encode the video (e.g., into a compressed format) using a compression technique prior to transmission. The decoder may receive the compressed video and decode the video (e.g., into a decompressed format). The systems and methods described herein may process video content using a codec that enables encoding and decoding video content associated with a plurality of resolutions.

Encoding video may comprise partitioning a frame of video data into a plurality of coding tree units (CTUs) or macroblocks that each comprising a plurality of pixels. The CTUS or macroblock may be partitioned into coding units (CUs) or coding blocks. The terms coding unit and coding block may be used interchangeably herein. The encoder may generate a prediction of each current CU based on previously encoded data. The prediction may comprise intra-prediction, which is based on previously encoded data of the current frame being encoded. The prediction may comprise inter-prediction, which is based on previously encoded data of a previously encoded reference frame. The inter-prediction stage may comprise determining a prediction unit (PU) (e.g., a prediction area) using motion compensation by determining a PU that best matches a prediction region in the CU. The encoder may generate a residual signal by determining a difference between the determined PU from the prediction region in the CU. The residual signals may then be transformed using, for example, a discrete cosine transform (DCT), which may generate coefficients associated with the residuals. The encoder may then perform a quantization process to quantize the coefficients. The transformation and quantization processes may be performed on transform units (Tus) based on partitions of the CUs. The compressed bitstream comprising video frame data may then be transmitted by the encoder. The transmitted compressed bitstream may comprise the quantized coefficients and information to enable the decoder to regenerate the prediction blocks, such as motion vector associated with the motion compensation. The decoder may receive the compressed bitstream and may decode the compressed bitstream to regenerate the video content.

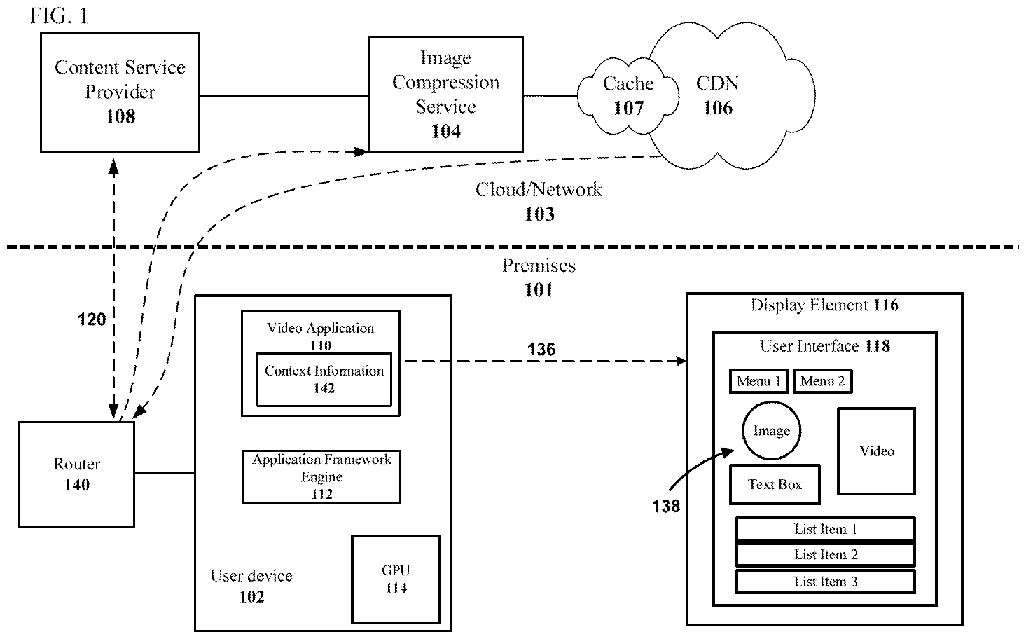

FIG. 1 shows an example system 100. The system 100 may comprise various devices located, for example, at a premises 101. The premises 101 may comprise a home, a business, or any other bounded geographic location.

The system may comprise a user device 102 located at premises 101. The user device 102 may comprise, for example, a laptop computer, a desktop computer, a mobile phone, a television, a set-top box, a tablet, a wearable computing device, a mobile computing device, or any other computing device configured to receive and/or output network traffic.

The user device 102 may be configured to display an application or website that a user may utilize to facilitate access to a service or content provided by a service provider, such as content service provider 108. The application may comprise a streaming client application, such as video application 110, that may connect to a server of a content service provider 108 in order to request and receive content from the content service provider 108. The user device 102 may be configured to receive recorded content items in a base media file format (BMFF), in a standard format determined by the Moving Picture Experts Group (MPEG), such as a transport stream (TS) defined by the MPEG, for example MPEG-TS, or the like. The user device 102 may be configured to receive the content and output the content for consumption by the user. The user device 102 may be configured to receive live streamed content and playback or output the live streamed content.

The user device 102 may comprise a graphics processing unit (GPU) 114. The GPU 114 may be used by the user device 102 for local image processing. The GPU 114 may comprise memory. Images, videos, and other interface elements, such as interface elements 138 may be converted or compressed to textures and uploaded to the GPU 114. The images, videos, or other interface elements may be poster art, thumbnails or banners associated with the content to be displayed by the user interface, such as user interface 118. The application framework engine 112, and/or other parts of the user device 102, may upload or send textures to the GPU 114. The uploaded textures of the GPU 114 may be decoded by the GPU 114 for display by the video application 110 on user interface 118.

The user device 102 may comprise an application framework engine 112. The application framework engine 112 may be configured to communicate with the content service provider 108, the image compression service 104, and/or the content delivery network (CDN) 106. The application framework engine 112 may request dynamic texture compression services, such as those provided by image compression service 104, from the content service provider 108, the image compression service 104, and/or the content delivery network (CDN) 106. The application framework engine 112 may be configured to request dynamic texture compression based on context information 142. The application framework engine 112 may be configured to download or receive compressed textures of images. The application framework engine 112 may be configured to upload or send compressed texture of images to the GPU 114. The application framework engine 112 may receive user interface definitions, elements, and/or objects by fetching URLs of the original user interface definitions, elements, and/or objects from the content service provider and sending the URLs to the dynamic compression service to be compressed. If the URLs of the user interface definitions, elements, and/or objects point to cached and compressed versions, than the application framework engine 112 may request the already compressed and cached versions of the user interface definitions, elements, and/or objects from the cache 107.

The application framework engine 112 may be any other framework or engine that enables dynamic texture compression and is not meant to be limiting the system 100 or the methods described herein.

The user device 102 may comprise a display element 116. In some scenarios, the display element 116 may be separate devices from the user device 102. The user device 102 may be communicatively coupled to the display element 116 via a wired connection, a cable, or another network (e.g., a local area network).

The user device 102 may comprise a video application 110. The video application 110 may comprise a video streaming application, service, and/or the like, such as a content browser. The video application 110 may be configured to cause display of a user interface 118. The dotted line 136 in FIG. 1 indicates that the user interface unit 118 may cause rendering of the example user interface 118 on the display element 116. The video application 110 may receive user interface data from the content service provider 108. The user interface data may be processed by the video application 110 to cause display of the user interface 118. The user interface 118 may be displayed on the display element 116. The display element 116 may comprise a television, screen, monitor, projector, and/or the like.

The user interface 118 may be configured to allow the user to browse, navigate, access, playback, and/or the like available content, such as content from the content service provider 108 and/or the CDN 106. The user interface 118 may allow navigation between different content channels, content items, and/or the like. The user interface 118 may comprise a plurality of interface elements 138. The plurality of interface elements 138 may comprise menu items, image elements (e.g., which cause display of an image), such as poster art, thumbnails, and/or banners, video elements (e.g., which control display and playback of video), text elements (e.g., which display text information), list elements (e.g., which display an order list of interface elements). The plurality of interface elements 138 may comprise actionable interface elements, such as interface elements that may be clicked or otherwise interacted with to cause an action. An interface element may comprise an image, button, dropdown menu, slide bars, or any other kind of interactive element that may be used to select content.

The user interface data received from the content service provider 108 and/or the CDN 106 may comprise data indicating the plurality of interface elements 138. The user interface data may comprise action data indicating (e.g., defining) actions, functions, and/or the like. The action data may associate the actions, functions, and/or the like with corresponding interface elements 138 and/or interface states. Actions may cause playback of content, select content, navigate to content, navigate away from content, navigate a list of content, cause information to be shown, hide information, move to another view of the user interface (e.g., from a lower menu view to a higher menu view, from a view of content to a view of related content and/or linked content), change a setting of the user interface, change a setting of an interface element (e.g., change playback mode of a video module from pause, play, stop, rewind, fast forward).

The user interface 118 may have a plurality of different interface states. The interface states may be tracked (e.g., for a user, a session, and/or a device). The interface states may be tracked by the content service provider 108, the CDN 106, the user device 102, or a combination thereof. An interface state may change if a user causes an action to be triggered, navigates the user interface, and/or the like. The interface state may comprise a current view of the user interface, a viewing history (e.g., or of different view), a location in a hierarchy (e.g., or other ordering) of interface views. An interface state may comprise a state of the current view, such as a location of a cursor, location of a selection element (e.g., showing which interface element is selected), a scrolling location, navigation location, an indication of which elements are currently displayed on the user's display, an indication of interface elements not shown on a display on a current page, a combination thereof, and/or the like.

The context information 142 may comprise data indicative of an image, video, or other content entity, such as a show, series, actor, channel, event, and/or the like. The context information 142 may comprise data indicative of a content property. The context information 142 may comprise data indicating content that a user is currently watching. The context information 142 may comprise data indicating content available (e.g., accessible) from a current view of the user interface. The context information 142 may comprise metadata associated with content, such as a content title (e.g., episode title, movie title, show title), content identifier (e.g., unique identifier for an entity, show, etc.), uniform resource identifier (e.g., link for accessing content), and/or the like. The context information 142 may include information associated with incoming interface elements, such as interface elements 138. Such information may be to compress only certain interface elements or parts of individual interface elements.

The context information 142 may comprise data indicating one or more actions associated with a view. The one or more action may comprise purchasing, playing, pausing, fast-forwarding, rewinding, navigating, recording, scrolling, filtering, open information associated with content, sharing, a combination thereof, and/or the like. A view of the content may comprise a plurality of logical block. A logical block may comprise an ordering relative to other blocks. A logical block may comprise any of the one or more actions. A logical block may comprise a functional block, a block of code, an interface element, and/or the like. A logical block may comprise a button in the current view (e.g., with associated actions). A logical block may comprise a tile in the current view (e.g., with associated content and/or actions).

The context information 142 may comprise an indication of a location of a cursor within a current view. The context information 142 may comprise a current state associated with a user, such as a location of the cursor, which interface element is highlighted, which elements are scrolled on and/or off screen, user interface state, which menu is open/active, prior states of the user, and/or the like. The state information may be stored on the user device 102, on a server (e.g., associated with the content service provider 108 and/or the CDN 106), a combination thereof, and/or the like. The context information 142 may comprise information indicating images, videos, or other interface elements, such as interface elements 138, may need to be rendered to properly display the user interface 118. The context information 142 may comprise information indicating that parts or all of one or more images, videos, or other interface elements may not be compressed. The context information 142 may be received by the user device by the service provider, such as content service provider 108. The application framework engine 112 may be configured to request dynamic texture compression based on context information 142.

A router (which may also be referred to as a gateway) 140 may also be located at the premises 101. As shown by dotted lines 120, the router/gateway 140 may provide access to a content service provider 108, an image compression service 104, and a content delivery network (CDN) 106. The content service provider 108 and associated services, networks, systems, and devices, such as image compressions service 104 and CDN 106, may operate as a cloud service located on cloud/network 103, which may not be located on the premise 101. The content service provider 108 may also operate as a content distributor. The content service provider 108 may provide users with access to a variety of services or content. The router/gateway 140 may be configured to enable user devices, such as the user device 102, to establish a wired or wireless connection to the router/gateway 140 for purposes of communicating with the router/gateway 140 and other network apparatuses beyond the router/gateway 140. The router/gateway 140 may be configured to establish a wired and/or wireless local area network to which the devices may connect. For purposes of communicating wirelessly, the router/gateway 140 may implement a wireless access technology, such as the IEEE 802.11 (“Wi-Fi”) radio access technology. In other implementations, other radio access technologies may be employed, such as IEEE 802.16 or 802.20 (“WiMAX”), IEEE 802.15.4a (“Zigbee”), or 802.15.3c (“UWB”). For purposes of communicating with the router/gateway 140 via a wired connection, the gateway may be configured to implement a wired local area network technology, such as IEEE 802.3 (“Ethernet”) or the like.

The router/gateway 140 may be configured to communicate with the CDN 106. The router/gateway 140 may communicate with the CDN 106 via any of a variety of communications mediums, such as a coaxial cable network, a fiber-optic cable network, a hybrid fiber-coaxial (HFC) network, a satellite transmission channel, or the like. When part of a cable television system, the CDN 106 may comprise a cable modem termination system (CMTS).

The router/gateway 140 may have an associated network address that uniquely identifies the router/gateway 140 on the CDN 106. The network address may comprise, for example, an internet protocol (IP) address. The router/gateway 140 may be configured to perform network address translation (NAT) when sending packets of data from a user device, such as the user device 102, to the CDN 106. Such network address translation may involve changing a source address in the header of packets received from the user device and destined for the CDN 106, from the local IP address of the user device on the local area network established by the router/gateway at the premises 101 to the network address (e.g., IP address) of the router/gateway 140 on the CDN 106.

The CDN 106 may provide various services to user devices, such as the user device 102, and may include the appropriate infrastructure for these services. For example, the CDN 106 may include one or more network routers (not shown). The network routers may comprise one or more edge routers, which may provide connectivity to other networks, including the Internet, a telephone network, or the like. The CDN 106 may comprise a cache, such as cache 107. The cache 107 may be configured to store the compressed images, videos, and/or interface elements. The cache 107 may send the compressed images, videos, and/or interface elements via the router 140 to the user device 102.

The content service provider 108 and/or the CDN 106 may comprise one or more content servers (not shown) that are configured to send, e.g., stream, content to such user devices. The content server(s) may be configured to send, to a user device and based on a request from the user device, a variety of different types of content, including live content, video-on-demand content, or other content.

The content service provider 108 and/or the CDN 106 may also comprise an authorization system (not shown) that is configured to determine whether a user, or a user device associated with the user, is permitted to access a requested service or requested content. The CDN 106 may also comprise an account database (not shown), which may store records associated with users that have established accounts with the service provider for delivery of services or content to the user. The account database may store, for each user, information associated with the user's account. The account information for each user may comprise, for example, credentials associated with the user's account. The credentials may comprise, for example, an identifier associated with the user (e.g., a username, email address, or other identifier). The credentials may further comprise a password or other form of secure access token associated with the user identifier.

The content service provider 108 and/or the CDN 106 may further comprise a service provider gateway (not shown) that may be configured to communicate across the content service provider 108 and/or the CDN 106 with one or more, and potentially thousands of, router/gateways located at the premises of different users, including, for example, the router/gateway 140 located at the premises 101. The service provider gateway (not shown) may store, for each router/gateway connected to the content service provider and/or the CDN 106, information associating the unique IP address of the router/gateway on the content service provider and/or the CDN 106 with information identifying the user account associated with the user of that router/gateway.

The content service provider 106 may comprise an image compression service 104. The image compression service 104 may be a standalone service. The image compression service 104 may be configured to implement dynamic texture compression. The image compression service 104 may be configured to implement a lossy algorithm. For example, transform coding, such as Discrete Cosine Transform (DCT), color quantization, chroma subsampling, fractal compression, Ericsson Texture Compression 1 (ETC1), Ericsson Texture Compression 2 (ETC2), S3 Texture Compression (S3TC), and/or any other lossy texture compression algorithm or technique may suitable. The image compression service 104 may be configured to implement a lossless algorithm. For example, run-length encoding, area image compression, predictive compression, such as Differential pulse-code modulation (DPCM), entropy encoding such as Huffman coding, chain codes, Lempel-Ziv-Welch (LZW) encoding, DEFLATE encoding, and or any other lossless texture compression algorithm or technique may suitable.

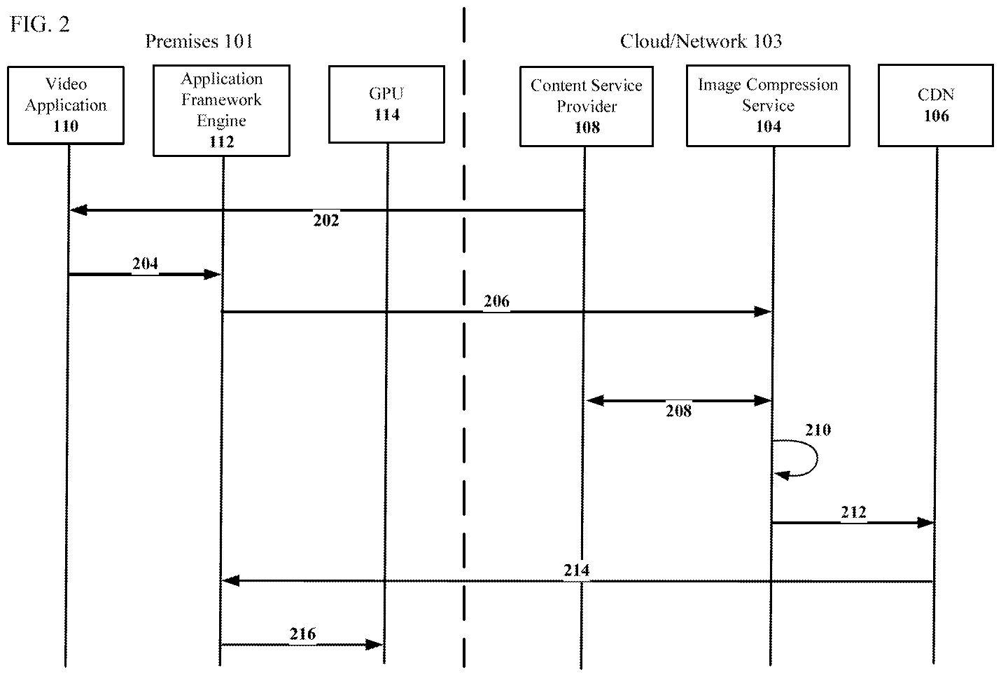

FIG. 2 shows an example flow diagram of an example method. The method may be employed in a system, such as the system of FIG. 1. The method may be used for leveraging dynamic texture compression mechanisms for user interfaces on a user device, such as the user device 102 of FIG. 1, located on a premises, such as premises 101.

At step 202, the video application 110 of user device 102 may receive content, such as an image, video, or any other interface element, such as interface elements 138 of FIG. 1, from the content service provider 108 and/or the associated content delivery network 106 over a cloud/network 103. The video application 110 may be a streaming application. The content provided by the content service provider 108 to the video application 110 may be a website, a movie, a browser, a video game, and/or any other similar application that displays images and/or video. The video application 110 may display the content on a user interface, such as the user interface 118 in FIG. 1.

The user interface 118 may have a plurality of different interface states. The interface states may be tracked (e.g., for a user, a session, and/or a device). The interface states may be tracked by the content service provider 108, the CDN 106, the user device 102, or a combination thereof. An interface state may change if a user causes an action to be triggered, navigates the user interface, and/or the like. This information, such as context information 142 in FIG. 1, may comprise data indicative of an image, video, or other content entity, such as a show, series, actor, channel, event, and/or the like. The context information 142 may comprise data indicative of a content property. The context information 142 may comprise data indicating content that a user is currently watching. The context information 142 may comprise data indicating content available (e.g., accessible) from a current view of the user interface. The context information 142 may comprise information indicating images, videos, or other interface elements, such as interface elements 138 in FIG. 1, may need to be rendered to properly display the user interface 118. The video application 110 may receive the context information 142 from the content service provider 108, and/or the CDN 106. The video application 110 may have access to the context information 142 via the user device 102.

At step 204, the video application 110 may notify the application framework 112 that certain content is to be displayed on user interface 118. Alternatively, and/or in addition, the application framework may monitor the video application 110 and associate user interface 118 for content to be displayed on user interface 118. The context information 142 may be analyzed to determine the content to be displayed. The context information 142 may include the location information of the content, such as the URL of an image. The context information 142 may include information associated with incoming interface elements, such as interface elements 138. Such information may be to compress only certain interface elements or parts of one or more interface elements.

At step 206, the application framework engine 110 may send a request for dynamic texture compression of the content from the image compression service 104 associated with the content service provider 108. The request may comprise the location information of the content, such as the context information 142. The request may be based on the context information 142. The request may be to compress only certain interface elements, parts of one or more interface elements, all of the interface elements in the entirety, or any combination thereof.

At step 208, the image compression service 104 may communicate with the content service provider 108 to determine the original content based on the location information, such as context information 142. The context information 142 may include the URL of the original content to be displayed. The determination may be based on a database of URLs mapping to content, or any other method of tracking URLs of content. Alternatively, and/or in addition to, the image compression service 104 may make the determination without communicating with the content service provider 108. Such determination may be based on the URL indicating the content has previously been compressed and cached. The URL that indicates the content has been previously compressed and cached may point to a cache, such as cache 107 associated with CDN 106 as shown in FIG. 1. If the URL points to a cache, proceed to step 214.

Additionally, at step 208, if the URL does not point to a cache, the image compression service 104 may determine if the original content has previously been compressed. The determination may be based on whether the compressed content is present in a cache, such as cache 107 associated with the CDN 106. If it is determined that the content has previously been compressed and cached, proceed to step 214, otherwise if the content has not been compressed and cached, proceed to step 210.

At step 210 the image compression service 104 may compress the original content. The image compression service 104 may be configured to implement a lossy algorithm. For example, transform coding, such as Discrete Cosine Transform (DCT), color quantization, chroma subsampling, fractal compression, Ericsson Texture Compression 1 (ETC1), Ericsson Texture Compression 2 (ETC2), S3 Texture Compression (S3TC), and/or any other lossy texture compression algorithm or technique may suitable. The image compression service 104 may be configured to implement a lossless algorithm. For example, run-length encoding, area image compression, predictive compression, such as Differential pulse-code modulation (DPCM), entropy encoding such as Huffman coding, chain codes, Lempel-Ziv-Welch (LZW) encoding, DEFLATE encoding, and or any other lossless texture compression algorithm or technique may suitable.

At step 212, the image compression service 104 may cache the compressed image on a cache, such as the cache 107 associated with the CDN 106. The cache 107 may be configured to store the requested content. Storing the newly compressed image in the cloud may comprise changing the URL of the original image to a new URL associated with the newly compressed image stored in the cache 107. By changing the URL, a request for the image may automatically retrieve the new URL associated with the newly compressed image stored in the cache 107 instead of the old URL associated with the original uncompressed image stored by the content service provider 108. The CDN 106 may comprise one or more content servers (not shown) that are configured to send, e.g., stream, content to such user devices. The content server(s) may be configured to send, to a user device and based on a request from the user device, a variety of different types of content, including live content, video-on-demand content, or other content.

At step 214, the CDN 106 may send the compressed content stored on the cache 107 to the application framework engine 112. At step 216 the application framework engine 112 may upload/send the compressed content to the GPU 114. The GPU 114 may decode the compressed content to the original image for display on the user interface 118 of FIG. 1.

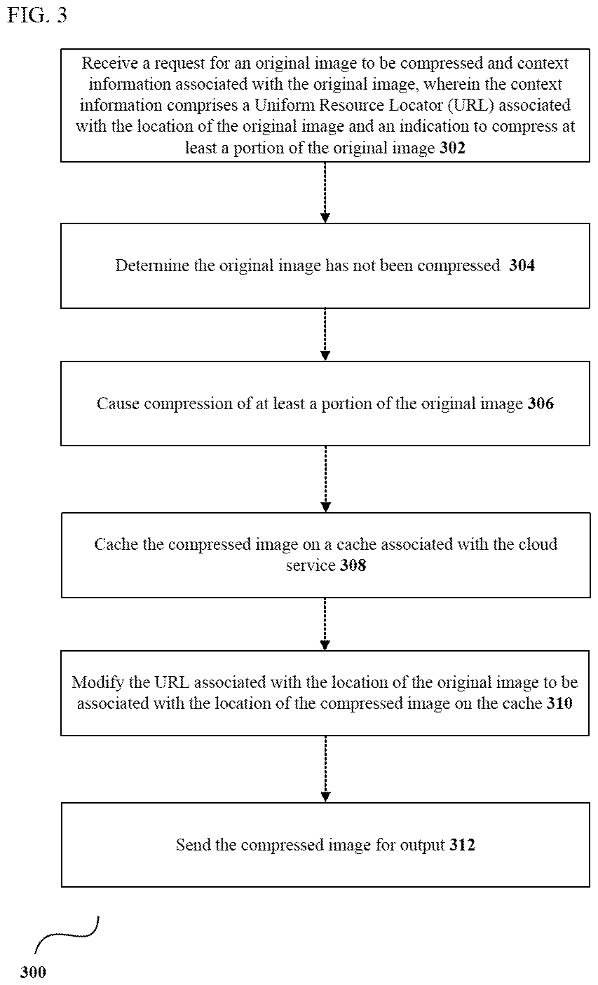

FIG. 3 shows an example method 300. The method 300 may be employed to leverage dynamic texture compression mechanisms for user interfaces on a user device, such as the user device 102 of FIG. 1, located on a premises, such as premises 101. The method 300 may be employed in the system illustrated in FIG. 1. The method 300 may be implemented as part of, or in combination with, the method illustrated in FIG. 2. The method of FIG. 3 may be performed by a computing device, such as any computing device illustrated in FIG. 1.

A user device, such as user device 102 in FIG. 1, may output a user interface for an application, website, game, or other media for a user to navigate. As a user navigates the application, website, game or other media, the user interface may attempt to display content for that media. The content to be displayed may consist of images, videos, menus, or other interface elements, such as poster art, thumbnails, banners, or the like. The user device may be configured to connect to a router, such as router 140 in FIG. 1, to receive such content from a computing device associated with a cloud service (e.g., dynamic texture compression service), such as content service provider 108, CDN 106, image compression service 104, or any combination of such computing devices. One at a time, when an image or other content, is to be displayed on the user interface, the computing device may send context information, such as context information 142 in FIG. 1, associated with the image to the user device via the router.

The context information may comprise data indicative of an original image, video, or other content entity, such as a show, series, actor, channel, event, and/or the like. The term original image may refer to an uncompressed image but is not meant to be limiting in any way. The term original image may be interchanged for any other term to describe an uncompressed image or an image that has not been previously compressed but is not meant to be limiting in any way. The context information may comprise data indicating content that a user is currently watching. The context information may comprise data indicating content available (e.g., accessible) from a current view of the user interface. The context information may comprise metadata associated with the content, such as a content title (e.g., episode title, movie title, show title), content identifier (e.g., unique identifier for an entity, show, etc.), uniform resource identifier (e.g., link for accessing content), and/or the like. The context information may comprise a URL associated with the location of the original image or content to be displayed. The context information may include compression information associated with incoming interface elements or the original image to be output on the user interface. Such compression information may be associated with which portion(s) or texture(s) of the original image to be output should be compressed, which image of a plurality of content should be compressed, whether to compress each image in its entirety or a combination thereof.

The user device may receive the context information. An application framework engine, such as the application framework engine 112 of user device 102 in FIG. 1, may receive the context information from a video streaming application, such as the video application 110 of user device 102 of FIG. 1.

The application framework or any other part of the user device may send the context information and a request to compress the original image to be output on the user interface to an image compression service, such as the image compression service 104 associated with content service provider 108 in FIG. 1, or any other computing device described above. The request to compress the original image may be based on a request for the user device to output the original image on the user interface.

At step 302, the computing device sent the context information and request to compress the image to be output by the user interface may receive the context information and the request to compress the original image.

At step 304, the computing device or any other computing device described above, such as the image compression service 104, may determine the original image has not been compressed based on the context information, which may comprise the URL associated with the location of the original image. The determination may further comprise determining a compressed version of the original image is not stored in a cache associated with the cloud service. The determination may be based on communicating with any or all of the other computing devices in FIG. 1 The determination may be based on a database on URLs mapping to content, or any other method of tracking URLs of content. Alternatively, and/or in addition to, computing device may make the determination without communicating with the content service provider 108 or other computing devices in FIG. 1.

At step 306, the computing device may cause compression of the original image based on the determination that the original image has not been compressed. The computing device may be configured to implement a lossy algorithm. For example, transform coding, such as Discrete Cosine Transform (DCT), color quantization, chroma subsampling, fractal compression, Ericsson Texture Compression 1 (ETC1), Ericsson Texture Compression 2 (ETC2), S3 Texture Compression (S3TC), and/or any other lossy texture compression algorithm or technique may suitable. The computing device may be configured to implement a lossless algorithm. For example, run-length encoding, area image compression, predictive compression, such as Differential pulse-code modulation (DPCM), entropy encoding such as Huffman coding, chain codes, Lempel-Ziv-Welch (LZW) encoding, DEFLATE encoding, and or any other lossless texture compression algorithm or technique may suitable.

At step 308, the computing device may cache the newly compressed image in a cache associated with any computing device associated with the cloud service, such as the CDN 106. The cache associated with the cloud service may be configured to store the requested content. The cache associated with the cloud service may have a cache expiry. The cache expiry may determine to automatically clear the cache after a pre-determined period of time, such as every hour, two hours, 24 hours, or the like.

At step 310, the computing device may modify the URL associated with the location of the original image to be associated with the location of the compressed image on the cache. Modifying the URL may comprise generating a new URL associated with the location of the compressed image and deleting the URL associated with the location of the original image.

At step 312, the computing device may send the compressed image to the user device for output on the user interface. Sending the compressed image to the user device for output on the user interface may comprise sending the modified URL to the user device. The user device may use the modified URL to download the compressed image to the user device. Sending the compressed image to the user device may cause the application framework engine 112, or other part of the user device to upload or send the compressed image to a GPU of the user device, such as the GPU 114. The GPU may decode the compressed content to the original image for output on the user interface. This may cause the output of the image to the user interface.

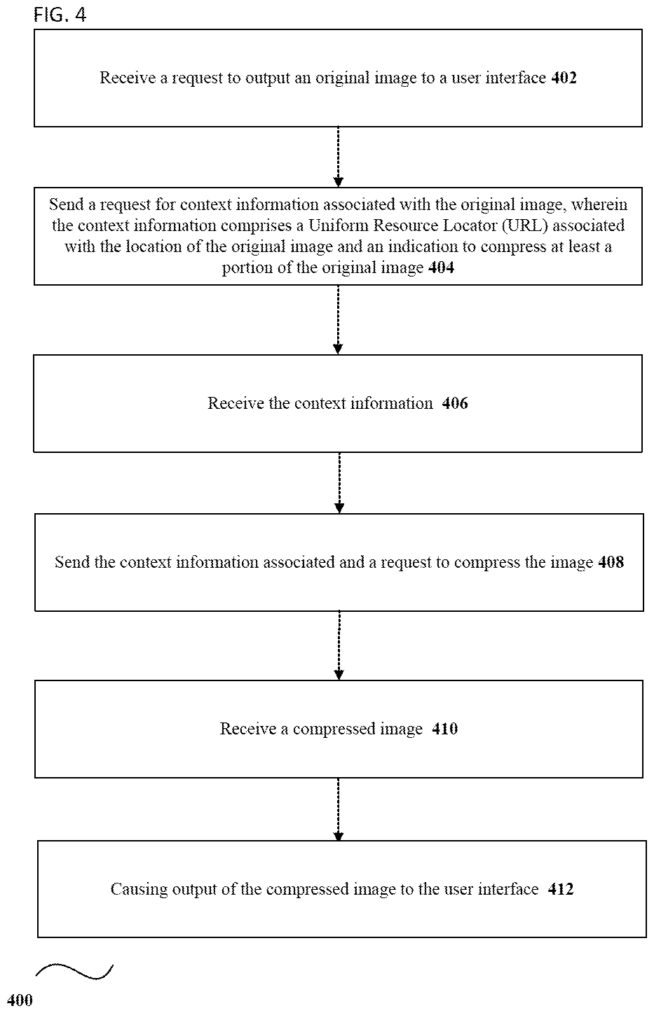

FIG. 4 shows an example method 400. The method 400 may be employed to leverage dynamic texture compression mechanisms for user interfaces on a user device, such as the user device 102 of FIG. 1, located on a premises, such as premises 101. The method 400 may be employed in the system illustrated in FIG. 1. The method 400 may be implemented as part of, or in combination with, the method illustrated in FIG. 2. The method of FIG. 4 may be performed by a computing device, such as any computing device illustrated in FIG. 1.

At step 402, a user device, such as user device 102 in FIG. 1, may output a user interface for an application, website, game, or other media for a user to navigate. One at a time, based on a user navigating the application, website, game or other media, the user device may receive a request to output an original image or other content for that media to the user interface. The content to be displayed may consist of images, videos, menus, or other interface elements, such as poster art, thumbnails, banners, or the like. The user device may be configured to connect to a router, such as router 140 in FIG. 1, to receive such content from a computing device associated with a cloud service (e.g., dynamic texture compression service), such as content service provider 108, CDN 106, image compression service 104, or any combination of such computing devices.

At step 404, the user device may send a request for context information, such as context information 142 in FIG. 1, associated with the original image to be output on the user interface to a computing device, such as one of the computing devices described above, via the router. Sending the context information of the original image and the request to compress the original image may cause the computing device to determine the original image based on the URL associated with the location of the original image. Determining the original image may comprise determining whether the original image has been previously compressed. Determining the original image may comprise downloading the original image.

The context information may comprise data indicative of an original image, video, or other content entity, such as a show, series, actor, channel, event, and/or the like. The term original image may refer to an uncompressed image but is not meant to be limiting in any way. The term original image may be interchanged for any other term to describe an uncompressed image or an image that has not been previously compressed but is not meant to be limiting in any way. The context information may comprise data indicating content that a user is currently watching. The context information may comprise data indicating content available (e.g., accessible) from a current view of the user interface. The context information may comprise metadata associated with the content, such as a content title (e.g., episode title, movie title, show title), content identifier (e.g., unique identifier for an entity, show, etc.), uniform resource identifier (e.g., link for accessing content), and/or the like. The context information may comprise a URL associated with the location of the original image or content to be displayed. The context information may include compression information associated with incoming interface elements or the original image to be output on the user interface. Such compression information may be associated with which portion(s) or texture(s) of the original image to be output should be compressed, which image of a plurality of content should be compressed, whether to compress each image in its entirety or a combination thereof.

At step 406, the user device may receive the context information. An application framework engine, such as the application framework engine 112 of user device 102 in FIG. 1, or any other part of the user device may receive the context information from a video streaming application, such as the video application 110 of user device 102 of FIG. 1, or any other part of the user device.

At step 408, the application framework engine or any other part of the user device may send the context information and a request to compress the original image to be output on the user interface to an image compression service, such as the image compression service 104 associated with content service provider 108 in FIG. 1, or any other computing device described above. The request to compress the original image may be based on the request for the user device to output the original image on the user interface.

The image compression service 104 may determine the original image has not been compressed based on the context information, which may comprise the URL associated with the location of the original image. The determination may further comprise determining a compressed version of the original image is not stored in a cache associated with the cloud service. The determination may be based on communicating with the any or all of the other computing devices in FIG. 1 The determination may be based on a database on URLs mapping to content, or any other method of tracking URLs of content. Alternatively, and/or in addition to, computing device may make the determination without communicating with the content service provider 108 or other computing devices in FIG. 1.

The computing device may cause compression of the original image based on the determination that the original image has not been compressed. The computing device may be configured to implement a lossy algorithm. For example, transform coding, such as Discrete Cosine Transform (DCT), color quantization, chroma subsampling, fractal compression, Ericsson Texture Compression 1 (ETC1), Ericsson Texture Compression 2 (ETC2), S3 Texture Compression (S3TC), and/or any other lossy texture compression algorithm or technique may suitable. The computing device may be configured to implement a lossless algorithm. For example, run-length encoding, area image compression, predictive compression, such as Differential pulse-code modulation (DPCM), entropy encoding such as Huffman coding, chain codes, Lempel-Ziv-Welch (LZW) encoding, DEFLATE encoding, and or any other lossless texture compression algorithm or technique may suitable.

The computing device may cache the newly compressed image in a cache associated with any computing device associated with the cloud service, such as the CDN 106. The cache associated with the cloud service may be configured to store the requested content. The cache associated with the cloud service may have a cache expiry. The cache expiry may determine to automatically clear the cache after a pre-determined period of time, such as every hour, two hours, 24 hours, or any other period of time.

The computing device may modify the URL associated with the location of the original image to be associated with the location of the compressed image on the cache. Modifying the URL may comprise generating a new URL associated with the location of the compressed image and deleting the URL associated with the location of the original image. The computing device may send the compressed image to the user device for output on the user interface. Sending the compressed image to the user device for output on the user interface may comprise sending the modified URL to the user device.

At step 410, the user device may receive the compressed image from the computing device. Receiving the compressed image may comprise receiving the modified URL from the computing device. The user device may use the modified URL to download the compressed image to the user device. Receiving the compressed image may cause the application framework engine 112, or other part of the user device to upload or send the compressed image to a GPU of the user device, such as the GPU 114. The GPU may decode the compressed content to the original image for output on the user interface. At step 412, receiving the compressed image may cause the output of the image to the user interface.

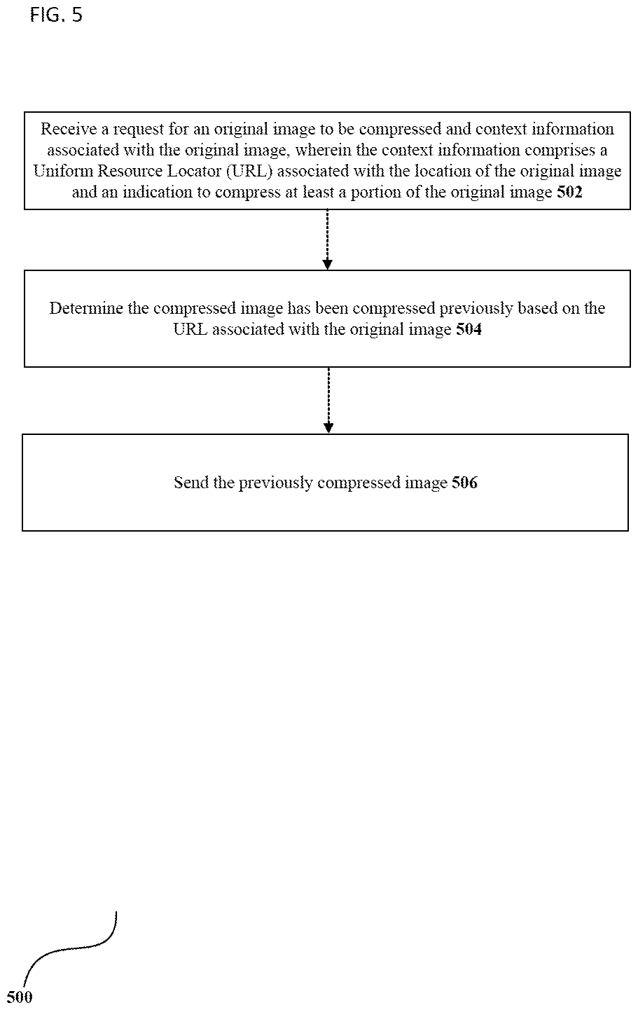

FIG. 5 shows an example method 500. The method 500 may be employed to leverage dynamic texture compression mechanisms for user interfaces on a user device, such as the user device 102 of FIG. 1, located on a premises, such as premises 101. The method 500 may be employed in the system illustrated in FIG. 1. The method 500 may be implemented as part of, or in combination with, the method illustrated in FIG. 2. The method of FIG. 5 may be performed by a computing device, such as any computing device illustrated in FIG. 1.

A user device, such as user device 102 in FIG. 1, may output a user interface for an application, website, game, or other media for a user to navigate. As a user navigates the application, website, game or other media, the user interface may attempt to display content for that media. The content to be displayed may consist of images, videos, menus, or other interface elements, such as poster art, thumbnails, banners, or the like. The user device may be configured to connect to a router, such as router 140 in FIG. 1, to receive such content from a computing device associated with a cloud service (e.g., dynamic texture compression service), such as content service provider 108, CDN 106, image compression service 104, or any combination of such computing devices. One at a time, when an image or other content, is to be displayed on the user interface, the computing device may send context information, such as context information 142 in FIG. 1, associated with the image to the user device via the router.

The context information may comprise data indicative of an original image, video, or other content entity, such as a show, series, actor, channel, event, and/or the like. The term original image may refer to an uncompressed image but is not meant to be limiting in any way. The term original image may be interchanged for any other term to describe an uncompressed image or an image that has not been previously compressed but is not meant to be limiting in any way. The context information may comprise data indicating content that a user is currently watching. The context information may comprise data indicating content available (e.g., accessible) from a current view of the user interface. The context information may comprise metadata associated with the content, such as a content title (e.g., episode title, movie title, show title), content identifier (e.g., unique identifier for an entity, show, etc.), uniform resource identifier (e.g., link for accessing content), and/or the like. The context information may comprise a URL associated with the location of the original image or content to be displayed. The context information may include compression information associated with incoming interface elements or the original image to be output on the user interface. Such compression information may be associated with which portion(s) or texture(s) of the original image to be output should be compressed, which image of a plurality of content should be compressed, whether to compress each image in its entirety or a combination thereof.

The user device may receive the context information. An application framework engine, such as the application framework engine 112 of user device 102 in FIG. 1, or any other part of the user device may receive the context information from a video streaming application, such as the video application 110 of user device 102 of FIG. 1, or any other part of the user device.

The application framework or any other part of the user device may send the context information and a request to compress the original image to be output on the user interface to an image compression service, such as the image compression service 104 associated with content service provider 108 in FIG. 1, or any other computing device described above. The request to compress the original image may be based on a request for the user device to output the original image on the user interface.

At step 502, the computing device sent the context information and request to compress the image to be output by the user interface may receive the context information and the request to compress the original image.

At step 504, the computing device or any other computing device described above, such as the image compression service 104, may determine the original image has been compressed previously based on the context information, which may comprise the URL associated with the location of the original image. The determination may further comprise determining a compressed version of the original image is stored in a cache associated with the cloud service. The determination may be based on communicating with any or all of the other computing devices in FIG. 1 The determination may be based on a database on URLs mapping to content, or any other method of tracking URLs of content. Alternatively, and/or in addition to, computing device may make the determination without communicating with the content service provider 108 or other computing devices in FIG. 1.

At step 506, the computing device may send the previously compressed image to the user device for output on the user interface. Sending the previously compressed image to the user device for output on the user interface may comprise sending the URL associated with the compressed image on the cache to the user device. The user device may use the URL to download the compressed image to the user device. Sending the previously compressed image to the user device may cause the application framework engine 112, or other part of the user device to upload or send the compressed image to a GPU of the user device, such as the GPU 114. The GPU may decode the compressed content to the original image for output on the user interface. This may cause the output of the image to the user interface.

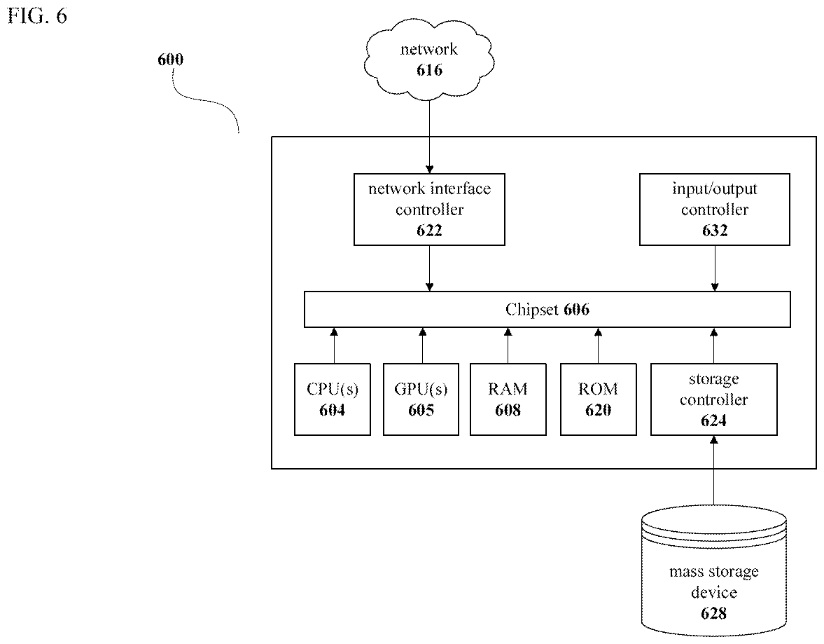

FIG. 6 shows an example computing device 600 that may represent any of the various devices or entities shown in FIG. 1, including, for example, the user device 102, the router/gateway 140, the image compression service 104, and the various devices associated with the content service provider 108 and/or the content delivery network 106. The computing device 600 shown in FIG. 6 may comprise any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 2-4.

The computing device 600 may comprise a baseboard, or “motherboard,” which is a printed circuit board to which a multitude of components or devices may be connected by way of a system bus or other electrical communication paths. One or more central processing units (CPUs or “processors”) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random-access memory (RAM) 608 used as the main memory in the computing device 600. The chipset 606 may provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems of the system 100. The chipset 606 may comprise functionality for providing network connectivity through a network interface controller (NIC) 622. A NIC 622 may be capable of connecting the computing device 600 to other computing nodes over the system 100. It should be appreciated that multiple NICs 622 may be present in the computing device 600, connecting the computing device to other types of networks and remote computer systems. The NIC 622 may be configured to implement a wired local area network technology, such as IEEE 802.3 (“Ethernet”) or the like. The NIC 622 may also comprise any suitable wireless network interface controller capable of wirelessly connecting and communicating with other devices or computing nodes on the system 100. For example, the NIC 622 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 600 may be connected to a mass storage device 628 that provides non-volatile storage (i.e., memory) for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 628 is characterized as primary or secondary storage or the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may read information from the mass storage device 628 by detecting the physical states or characteristics of one or more particular locations within the physical storage units.

In addition to the mass storage device 628 described herein, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 628 depicted in FIG. 5, may store an operating system utilized to control the operation of the computing device 600. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described herein. The computing device 600 may have access to computer-readable storage media storing computer-executable instructions, which, when executed by the computing device 600, may perform the methods described in relation to FIGS. 2-4.

A computing device, such as the computing device 600 depicted in FIG. 5, may also comprise an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not comprise all of the components shown in FIG. 6, may comprise other components that are not explicitly shown in FIG. 6, or may utilize an architecture completely different than that shown in FIG. 6.

As described herein, a computing device may be a physical computing device, such as the computing device 600 of FIG. 6. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.”. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a computing device associated with a cloud service and from a user device located at a premises outputting a user interface, a request for an original image to be compressed and context information associated with the original image, wherein the context information comprises a Uniform Resource Locator (URL) associated with the location of the original image and an indication to compress at least a portion of the original image;
determining, by the computing device and based on the URL associated with the location of the original image, the original image has not been compressed;
causing, by the computing device and based on the context information and determining the original image has not been compressed, compression of at least a portion of the original image;
caching the compressed image on a cache associated with cloud service;
modifying the URL associated with the location of the original image to be associated with the location of the compressed image on the cache; and
sending, to the user device, the compressed image for output on the user interface.

2. The method of claim 1, wherein the determining the original image has not been compressed further comprises:
determining a compressed version of the original image is not stored in the cache associated with the cloud service.

3. The method of claim 1, wherein the request for the original image to be compressed is based on a request for the user device to output the original image on the user interface.

4. The method of claim 1, wherein the cache associated with the cloud service is cleared automatically after a pre-determined period of time.

5. The method of claim 1, wherein the sending, to the device, the compressed image comprises sending, to the user device, the modified URL associated with the location of the compressed image on the cache.

6. The method of claim 1, wherein the sending, to the user device, the compressed image causes:
downloading, by an application framework engine associated with the user device, the compressed image; and
outputting the image to the user interface.

7. The method of claim 1, wherein the sending, to the user device, the compressed image causes:
sending, by an application framework engine associated with the user device and to a GPU of the user device, the compressed image; and
outputting the image to the user interface.

8. A method comprising:
receiving, by a user device located at a premises outputting a user interface, a request to output an original image to the user interface;
sending, by the user device, a request for context information associated with the original image, wherein the context information comprises a Uniform Resource Locator (URL) associated with the location of the original image and an indication to compress at least a portion of the original image;
receiving, by the user device, the context information;
sending, to a computing device associated with a cloud service and based the indication to compress at least a portion of the original image, the context information of the image and a request to compress the original image;
receiving, by the user device and from the computing device, a compressed image; and
causing output of the compressed image to the user interface.

9. The method of claim 8, wherein the determining the original image has been compressed further comprises:
determining the URL of the compressed image is associated with a location on a cache associated with the cloud service.

10. The method of claim 9, wherein the cache associated with the cloud service is cleared automatically after a period of time.

11. The method of claim 8, wherein receiving the compressed image further comprises receiving a modified URL associated with the location of the compressed image on a cache associated with the cloud service.

12. The method of claim 8, wherein the sending the context information of the original image and the request to compress the original image causes the computing device to determine, based on the URL associated with the location of the original image, the original image.

13. The method of claim 8, further comprising sending, by an application framework engine of the device and to a GPU of the device, the compressed image.

14. A method comprising:
receiving, by a computing device associated with a cloud service and from a user device located at a premises outputting a user interface, a request for an original image to be compressed and context information associated with the original image, wherein the context information comprises a Uniform Resource Locator (URL) associated with the location of the original image and indication to compress a least a portion of the original image;
determining, by the computing device and based on the URL associated with the location of the original image, the original image has been compressed previously; and
sending, to the user device, the previously compressed image.

15. The method of claim 14, wherein the determining the original image has been compressed previously further comprises:
determining the URL associated with the location of the original image is associated with a cache associated with the cloud service.

16. The method of claim 15, wherein the cache associated with the cloud service is cleared automatically after a pre-determined period of time.

17. The method of claim 14, wherein the sending, to the user device, the compressed image causes:
downloading, by an application framework engine associated with the user device, the compressed image; and
outputting the image to the user interface.

18. The method of claim 14, wherein the sending, to the user device, the compressed image causes:
sending, by an application framework engine associated with the user device and to a GPU of the user device, the compressed image; and
outputting the image to the user interface.

19. The method of claim 14, wherein the indication to compress a least a portion of the original image comprises an indication to compress each portion of the original image.

20. The method of claim 14, wherein the indication to compress a least a portion of the original image comprises an indication to compress a single portion of the original image.
